(19) United States
(12) Patent Application Publication
(10) Pub. No.: US 2015/0003985 A1
(43) Pub. Date: Jan. 1, 2015

(54) MOVEABLE SURFACE FEATURES FOR WIND TURBINE ROTOR BLADES

(71) Applicant: General Electric Company, Schenectady, NY (US)

(72) Inventors: Christopher Daniel Caruso, Greenville, SC (US); James Robert Tobin, Simpsonville, SC (US)

(73) Assignee: General Electric Company

(21) Appl. No.: 13/928,490

(22) Filed: Jun. 27, 2013

(51) Int. Cl. F03D 7/02

(52) U.S. Cl. CPC F03D 7/022
USPC 416/23

(57) ABSTRACT

Rotor blades for a wind turbines include a shell having a pressure side and a suction side and a plurality of surface features disposed adjacent at least one of the pressure side and the section side. The plurality of surface features is further moveable between a spoiler position and a vortex generator position.

### BACKGROUND OF THE INVENTION

The subject matter disclosed herein relates to rotor blades and, more specifically, to moveable surface features for wind turbine rotor blades.

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The particular size of wind turbine rotor blades is a significant factor contributing to the overall efficiency of the wind turbine. Specifically, increases in the length or span of a rotor blade may generally lead to an overall increase in the energy production of a wind turbine. Accordingly, efforts to increase the size of rotor blades aid in the continuing growth of wind turbine technology and the adoption of wind energy as an alternative energy source. However, as rotor blade sizes increase, so do the loads transferred through the blades to other components of the wind turbine (e.g., the wind turbine hub and other components). For example, longer rotor blades result in higher loads due to the increased mass of the blades as well as the increased aerodynamic loads acting along the span of the blade. Such increased loads can be particularly problematic in high-speed wind conditions, as the loads transferred through the rotor blades may exceed the load-bearing capabilities of other wind turbine components.

Certain surface features, such as spoilers may be utilized to separate the flow of air from the outer surface of a rotor blade, thereby reducing the lift generated by the blade and reducing the loads acting on the blade. Other surface features, such as vortex generators, may delay separation of the air flowing over a rotor blade to increase loads during periods of decreased wind. However, both of these surface features may be designed to be permanently disposed along the outer surface of the rotor blade. As such, the amount of lift generated by the rotor blade is reduced or increased regardless of the conditions in which the wind turbine is operating and does not allow for any dynamic control.

Accordingly, alternative surface features for rotor blades would be welcome in the art.

### BRIEF DESCRIPTION OF THE INVENTION

In one embodiment, a rotor blade for a wind turbine is disclosed. The rotor blade includes a shell having a pressure side and a suction side and a plurality of surface features disposed adjacent at least one of the pressure side and the section side. The plurality of surface features is further moveable between a spoiler position and a vortex generator position.

In another embodiment, a wind turbine is disclosed. The wind turbine includes a tower, a nacelle mounted atop the tower, a rotor hub coupled to the nacelle; and a plurality of rotor blades extending outwardly from the rotor hub. At least one of the plurality of rotor blades a shell having a pressure side and a suction side and a plurality of surface features disposed adjacent at least one of the pressure side and the section side. The plurality of surface features is further moveable between a spoiler position and a vortex generator position.

These and additional features provided by the embodiments discussed herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference numerals and in which:

FIG. 1 is a perspective view of a wind turbine according to one or more embodiments shown or described herein;

FIG. 2 is a perspective view of a rotor blade having moveable surface features in spoiler generator positions according to one or more embodiments shown or described herein;

FIG. 3 is a perspective view of a rotor blade having moveable surface features in vortex generator positions according to one or more embodiments shown or described herein;

FIG. 4 is a perspective view of a rotor blade having moveable surface features in intermediate positions according to one or more embodiments shown or described herein;

FIG. 5 is a perspective view of a rotor blade having moveable surface features in both spoiler positions and vortex generator positions according to one or more embodiments shown or described herein;

FIG. 6 is a perspective view of a rotor blade having moveable surface features in recessed positions according to one or more embodiments shown or described herein; and

FIG. 7 is a cross-sectional view of a rotor blade having moveable surface features according to one or more embodiments shown or described herein.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

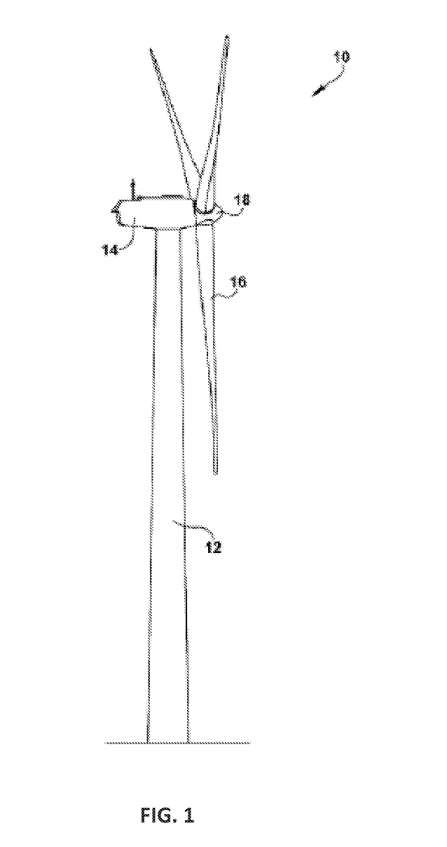

Referring to FIG. 1, a wind turbine 10 is illustrated. The wind turbine 10 includes a tower 12 with a nacelle 14 mounted thereon. A plurality of rotor blades 16 are mounted to a rotor hub 18, which is, in turn, connected to a main flange that turns a main rotor shaft. The wind turbine power generation and control components are housed within the nacelle 14. It should be appreciated that the view of FIG. 1 is provided for illustrative purposes only to place the present subject matter in an exemplary field of use. Thus, one of ordinary skill in the art should readily appreciate that the present subject matter need not be limited to any particular type of wind turbine configuration.

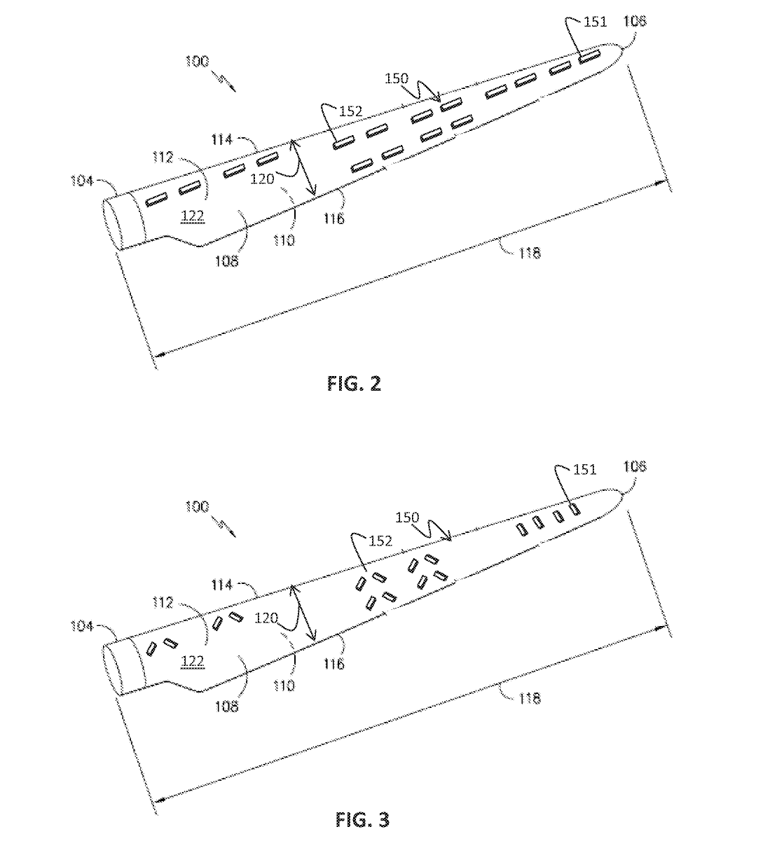

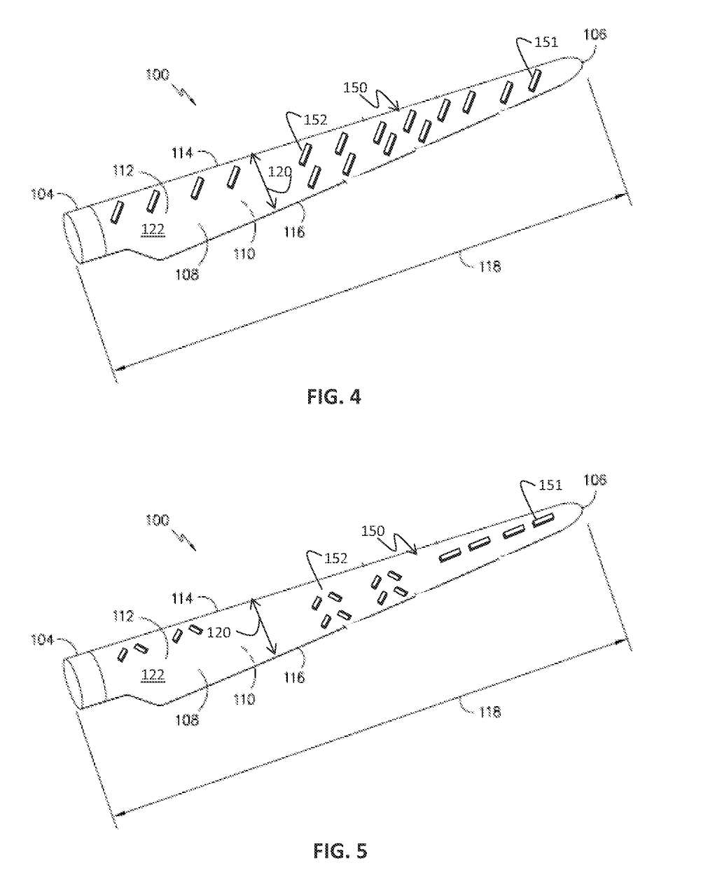

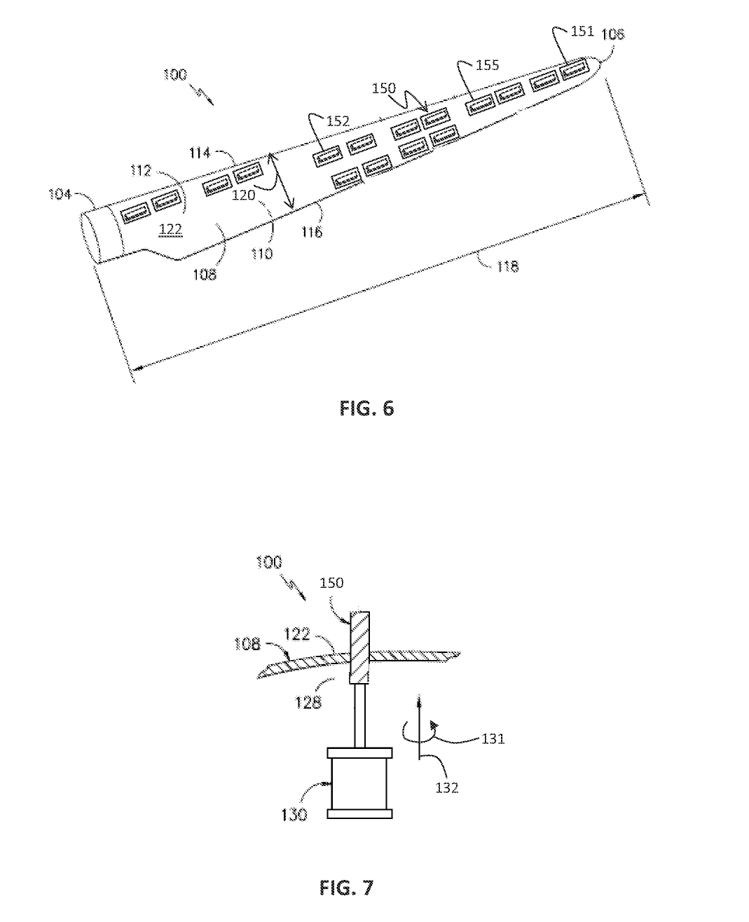

Referring now to FIGS. 2-7, a rotor blade 100 having a plurality of moveable surface features 150 in accordance with aspects of the present subject matter. In particular, FIG. 2 illustrates a perspective view of the rotor blade 100 having a plurality of surface features 150 in spoiler positions. FIG. 3 illustrates a perspective view of the rotor blade 100 having a plurality of surface features 150 in various vortex generator positions. FIG. 4 illustrates a perspective view of the rotor blade 100 having a plurality of surface features 150 in intermediate positions. FIG. 5 illustrates a perspective view of the rotor blade 100 having a plurality of surface features 150 in both spoiler positions and vortex generator positions. FIG. 6 illustrates a perspective view of the rotor blade 100 having a plurality of surface features 150 in recessed positions. Additionally, FIG. 7 illustrates a partial cross-sectional view of the rotor blade 100 having moveable surface features 150.

In general, the disclosed rotor blade 100 may include a blade root 104 configured for mounting the rotor blade 100 to the hub 18 of the wind turbine 10 (FIG. 1) and a blade tip 106 disposed opposite the blade root 104. A shell 108 of the rotor blade 100 may generally be configured to extend between the blade root 104 and the blade tip 106 and may serve as the outer casing/covering having an outer surface 122 of the rotor blade 100. In several embodiments, the shell 108 may define a substantially aerodynamic profile, such as by defining a symmetrical or cambered airfoil-shaped cross-section. As such, the shell 108 may define a pressure side 110 and a suction side 112 extending between a leading edge 114 and a trailing edge 116. Further, the rotor blade 100 may have a span 118 defining the total length between the blade root 104 and the blade tip 106 and a chord 120 defining the total length between the leading edge 114 and the trialing edge 116. As is generally understood, the chord 120 may vary in length with respect to the span 118 as the rotor blade 100 extends from the blade root 104 to the blade tip 106.

In several embodiments, the shell 108 of the rotor blade 100 may be formed as a single, unitary component. Alternatively, the shell 108 may be formed from a plurality of shell components. For example, the shell 108 may be manufactured from a first shell half generally defining the pressure side 110 of the rotor blade 100 and a second shell half generally defining the suction side 112 of the rotor blade 100, with the shell halves being secured to one another at the leading and trailing edges 114, 116 of the blade 100. Additionally, the shell 108 may generally be formed from any suitable material. For instance, in one embodiment, the shell 108 may be formed entirely from a laminate composite material, such as a carbon fiber reinforced laminate composite or a glass fiber reinforced laminate composite. Alternatively, one or more portions of the shell 108 may be configured as a layered construction and may include a core material, formed from a lightweight material such as wood (e.g., balsa), foam (e.g., extruded polystyrene foam) or a combination of such materials, disposed between layers of laminate composite material.

It should be appreciated that the rotor blade 100 may also include one or more internal structural components. For example, in several embodiments, the rotor blade 100 may include one or more shear webs (not shown) extending between corresponding spar caps (not shown). However, in other embodiments, the rotor blade 100 of the present disclosure may have any other suitable internal configuration.

Still referring to FIGS. 2-7, the rotor blade 100 comprises one or more surface features 150. The plurality of surface features 150 are moveable between a spoiler position (as best illustrated in FIG. 2) and a vortex generator position (as best illustrated in FIG. 3). As used herein, “moveable” refers to the entire surface feature 150 being moveable, or one or more portions of the surface feature being moveable. For instance, in some embodiments, the surface feature 150 may comprise a central pin around which the rest of the surface feature rotates between the spoiler position and the vortex generator position.

As used herein, the “spoiler position” refers to a position of the plurality of surface features 150 that separates air flowing over the rotor blade 100 from the outer surface 122 of the shell 108, thereby reducing the lift generated by the blade 100 and decreasing the loads transferred through the blade 100 to other components of the wind turbine 10 (e.g., the rotor hub 18 of the wind turbine 10 illustrated in FIG. 1). For example, as best illustrated in FIG. 2, the plurality of surface features 150 may be substantially parallel with the span 118 of the rotor blade 100 when in the spoiler position. The spoiler position may thereby be utilized during increased loading on the rotor blade 100 (e.g., during operation in high-speed wind conditions). In some embodiments, the space between the surface features 150 in spoiler positions may be selected to ensure adequate spacing when said surface features 150 are moved to vortex generator positions as should be appreciated herein. The spacing may depend on, for example, the size of the surface features, the position on the rotor blade 100 with respect to the span and/or the chord, or any other relevant factors. For example, in some embodiments, the space between two of surface features 150 may be less than, greater than or equal to the length of a surface feature 150.

As also used herein, the “vortex generator position” refers to a position of the plurality of surface features 150 that delays flow separation of air flowing over the rotor blade 100 from the outer surface 122 of the shell 108. While in the vortex generator position, the plurality of surface features 150 may comprise a plurality of vanes, bumps, ridges and/or other configurations to create a vortex in the air flowing along the outer surface 122 of the shell 108. Vortices created by the plurality of surface features 150 in the vortex generator position can increase the forward momentum of the airflow, thereby encouraging the air to remain attached to the outer surface 122. The vortex generator position may thereby be utilized to increase loading on the rotor blade 100.

For example, as best illustrated in FIG. 3, the plurality of surface features 150 may be substantially parallel with the direction of the chord 120 (such as illustrated with a first surface feature 151 proximate the blade tip 106) or angled between the directions of the span 118 and the chord 120 (such as illustrated with a second surface feature 152 more proximate the blade root 104). In the later configurations, each of the plurality of surface features 150 in the vortex generator position may be facing the same direction, or may alternatively be facing opposite directions such that they form a plurality of V-like structures (as illustrated in FIG. 3). In even some embodiments, the plurality of surface features 150 may be in different vortex generator positions (e.g., a first and a second vortex generator position) such that the angle of each vortex generator position can be customized based on at least the position along the rotor blade 100.

Referring now to FIG. 4, in some embodiments, the plurality of surface features 150 may be moved into intermediate positions. As used herein, “intermediate positions” refer to positions between the spoiler position and the vortex generator position. Moving one or more of the plurality of surface features 150 into intermediate positions may allow for greater customization of air flow redirection as it passes over the outer surface 122 of the shell 108. Specifically, the load on the rotor blade 100 may be adjusted by moving the plurality of surface features 150 to any intermediate position between the spoiler position (which can decrease the load) and the vortex generator position (which can increase the load).

Referring now to FIG. 5, in even some embodiments, the plurality of surface features 150 may be moveable between the spoiler position and the vortex position independent of one another. The independent movement of the plurality of surface features 150 can allow for the manipulation of wind on the rotor blade 100 specific to the location along direction of the span 118 and/or the chord 120. For example, the plurality of surface features 150 may comprise a first surface feature 151 disposed more adjacent the blade tip 106 of the rotor blade and a second surface feature 152 disposed more adjacent the blade root 104 of the rotor blade 100. The first surface feature 151 and the second feature 152 may be moved to different positions such that the plurality of surface features 150 are in an overall hybrid position. For example, the first surface feature 151 may be moved to the spoiler position while the second surface feature 152 may be moved to a vortex generator position. In some of these embodiments, the first surface feature 151 may be more proximate the blade tip 106 and the second surface feature 152 may be more proximate the blade root 104. The hybrid positions may thereby be utilized to vary the air flow over the surface 122 of the shell 108 based on specific locations along the rotor blade 108.

The plurality of surface features 150 can comprise any material or materials suitable for manipulating airflow over the outer surface 122 of the shell 108. For example, in some embodiments, the plurality of surface features 150 and the shell 108 may comprise the same material (e.g., carbon fiber reinforced laminate, glass fiber reinforced laminate composite, etc.). In other embodiments, the plurality of surface features 150 may comprise a different material then the shell 108. In even some embodiments, some of the plurality of surface features 150 (e.g., the first surface feature 151) may comprise a material different than other surface features 150 (e.g., the second surface feature 152).

The plurality of surface features 150 may comprise any number of individual surface features 150 and may be disposed and distributed in a variety of locations with respect to the shell 108 of the rotor blade 100. For example, in some embodiments, the plurality of surface features 150 may be disposed on the suction side 112 of the rotor blade. In some embodiments, the plurality of surface features 150 may be disposed on the pressure side 110 of the rotor blade 100. In even some embodiments, the plurality of surface features may be disposed on both the suction side 112 and the pressure side 110 of the rotor blade 100.

Moreover, the plurality of surface features 150 may be disposed and spaced in many variations between the blade root 104 and the blade tip 106. For example, the plurality of surface features 150 may be spaced apart in the spanwise direction, the chordwise direction, or both the spanwise direction and the chordwise direction. It should be appreciated that the “spanwise direction” refers to the direction extending parallel to the span 118 of the rotor blade and that the “chordwise direction” refers to the direction extending parallel to the chord 120 of the rotor blade 100. In some embodiments, the plurality of surface features 150 may be evenly spaced apart. In other embodiments, the plurality of surface features may be spaced further apart towards either the blade root 104 or the blade tip 106 of the rotor blade 100 or even the leading edge 114 or the trailing edge 116 of the rotor blade 100.

Additionally, each of the plurality of surface features 150 may comprise any suitable length that allows it to move between the spoiler position and the vortex position as should be appreciated herein. In some embodiments, each of the plurality of surface features 150 may have the same length. In other embodiments, some of the plurality of surface features 150 (such as those more proximate the blade tip 106 and/or the leading edge 114) may have different lengths (e.g., smaller lengths) than the rest of the plurality of surface features 150 (such as those more proximate the blade root 104 and/or the trailing edge 116).

Referring now to FIG. 6, in some embodiments, the shell 108 may further comprise one or more openings 155 in at least the pressure side 110 and the suction side 112. The plurality of surface features 150 may additionally be moveable relative to the one or more openings 155 between a recessed position at least partially disposed within the shell 108 (as illustrated in FIG. 6) and an extended position at least partially extended out from the shell 108 (as illustrated in FIGS. 2-5).

While in the recessed position, the plurality of surface features 150 may thereby be at least partially recessed within the rotor blade 100 such that they do not impart the same re-directional influence on air flowing over the shell 108 as when they are in the extended position. For example, in some embodiments, the plurality of surface features 150 may move to a fully recessed position that is completely below or even with the outer surface 122 of the shell 108. In such embodiments, a top portion of the plurality of surface features 150 may be configured to define an aerodynamic profile generally corresponding to the aerodynamic profile of the outer surface 122 of the shell 108. In such embodiments, the plurality of surface features 150 may be substantially flush with the outer surface 122 such that they create a generally smooth and continuous aerodynamic profile between the shell 108 and the plurality of surface features 150. In other embodiments, the shell 108 may comprise an alternative or additional cover that closes the one or more openings 155 when one or more of the plurality of surface features 150 are in the recessed position.

While in the extended position, the plurality of surface features 150 may be moveable between the spoiler position and the vortex generator position. In some embodiments, at least two of the plurality of surface features 150 may be moveable between the recessed position and the extended position independent of one another.

Referring now to FIG. 7, a partial cross-sectional view is illustrated of the rotor blade 100 presented in FIGS. 1-6. In some embodiments, the rotor blade 100 may further comprise one or more actuators 130 disposed within the shell 108.

The one or more actuators 130 can be configured to move at least one of the plurality of surface features 150 in a rotational direction 131 (i.e. between the spoiler position and the vortex generator position) and/or in a vertical direction 132 (i.e., between the recessed position and the extended position). In some embodiments, the one or more actuators 130 can be additionally or alternatively configured to move at least one of the plurality of surface features 150 in an angular that changes the angle of the surface feature with respect to the rotor blade (e.g., similar to a full flap and no flap orientation for an airplane wing). Such embodiments can alter the angle of airflow as it passes over the surface feature 150 (e.g., when it is in the spoiler position). It should be appreciated that the actuator 130 may general comprise any suitable device or devices capable of moving at least one of the plurality of surface features 150 relative to the shell 108. For example, the actuator 130 may comprise any hydraulic, pneumatic, rack and pinion, worm gear, cam actuated, electro-magnetic, motorized or any other suitable type of device configured to move at least one of the plurality of surface features 150.

In some embodiments, each of the plurality of surface features 150 may be connected to its own individual actuator 130 or to multiple actuators 130 (e.g., one for movement in the rotational direction 131 and one for movement in the vertical direction 132). In some embodiments, multiple of the plurality of surface features 150 may be connected to the same actuator 130 such that those surface features 150 connected to the same actuator 130 move in unison.

Referring now to FIGS. 1-7, in some embodiments the plurality of surface features 150 can move between the spoiler position and the vortex generator based on the specific rotor blade 100 of the wind turbine. For example, in some embodiments, the wind turbine 10 may comprise at least a first blade and a second blade, both of which comprise a plurality of surface features 150 as described herein. In such embodiments, a first plurality of surface features 150 on a first rotor blade 100 may move between the spoiler position and the vortex generator position independent of a second plurality of surface features 150 on a second rotor blade 100 moving between the spoiler position and the vortex position. Specifically, the first plurality of surface features 150 of the first rotor blade 100 may move to one position (e.g., the spoiler position) while the second plurality of the surface features 150 of the second rotor blade 100 move to a different position (e.g., the vortex generator position or a recessed position). Such embodiments may allow for the adjustment of load to individual rotor blades 100 independent of other rotor blades 100. For example, if the pitch motor fails for one rotor blade 100, that rotor blade 100 may move the plurality of surface features 150 to the spoiler position to reduce the load that could have otherwise been controlled via the pitch motor. The other rotor blades 100 may then keep their respective surface features in any other position as required by the operating conditions.

Furthermore, in some embodiments the plurality of surface features 150 may be moved between the spoiler position and the vortex generation position based at least in part on a position of the rotor blade 100 with respect to the tower 12 (i.e., the position of the rotor blade 100 as it rotates throughout its cycle). For example, as the rotor blade 100 rotates toward the tower (i.e., it approaches the downward or 6 o'clock position), the plurality of surface features 150 for that rotor blade 100 may move to the spoiler position. Such embodiments can reduce the load on the rotor blade 100 as it approaches the tower 12 thereby assisting in the achievement of sufficient clearance between the two objects. The plurality of surface features 150 may thus be dynamically moved between positions throughout each rotational cycle of the rotor blade 100 based on different constraints and environmental conditions.

It should now be appreciated that surface features that move between spoiler positions and vortex generator positions can be disposed adjacent the suction and/or pressure sides of rotor blades to dynamically manage air flow loads based on external conditions (e.g., wind speed, power generation goals, etc.) and operational constraints (e.g., clearance requirements, rotational speed limitations, etc.). The surface features may move independent of other surface features on the same rotor blade and/or independent of other surface features on other rotor blades. Moreover, these surface features may further be moveable into a recessed position within the rotor blade when no spoiling or vortex generating is required.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed:

1. A rotor blade for a wind turbine, the rotor blade comprising:
a shell having a pressure side and a suction side; and,
a plurality of surface features disposed adjacent at least one of the pressure side and the section side, the plurality of surface features being moveable between a spoiler position and a vortex generator position.

2. The rotor blade of claim 1, wherein at least two of the plurality of surface features are moveable between the spoiler position and the vortex position independent of one another.

3. The rotor blade of claim 2, wherein a first of the plurality of surface features is in the spoiler position and a second of the plurality of surface features is in the vortex generator position.

4. The rotor blade of claim 3, wherein the first surface feature in the spoiler position is more proximate a blade tip than the second surface feature in the vortex generator position.

5. The rotor blade of claim 1 further comprising one or more actuators disposed within the shell, the one or more actuators configured to move at least one of the plurality of surface features between the spoiler position and the vortex generator position.

6. The rotor blade of claim 1, wherein the shell comprises one or more openings in at least one of the pressure side and the suction side, and wherein at least one of the plurality of surface features are moveable relative to the one or more openings between a recessed position at least partially disposed within the shell and an extended position at least partially extended out from the shell.

7. The rotor blade of claim 6, wherein at least one of the plurality of surface features are moveable between the spoiler position and the vortex generator position when in the extended position.

8. The rotor blade of claim 6, wherein at least two of the plurality of surface features are moveable between the recessed position and the extended position independent of one another.

9. The rotor blade of claim 6, wherein an outer portion of at least one of the plurality of surface features forms a continuous aerodynamic profile with the shell when the at least one surface feature is in the recessed position.

10. The rotor blade of claim 1, wherein a first of the plurality of surface features is in a first vortex generator position and a second of the plurality of surface features is in a second vortex generator position.

11. A wind turbine comprising:
a tower;
a nacelle mounted atop the tower;
a rotor hub coupled to the nacelle; and,
a plurality of rotor blades extending outwardly from the rotor hub, at least one of the plurality of rotor blades comprising:
a shell having a pressure side and a suction side; and,
a plurality of surface features disposed adjacent at least one of the pressure side and the section side, the plurality of surface features being moveable between a spoiler position and a vortex generator position.

12. The wind turbine of claim 11, wherein the plurality of surface features are moved between the spoiler position and the vortex generator position based at least in part on a position of the rotor blade with respect to the tower.

13. The wind turbine of claim 12, wherein at least one of the plurality of surface features is moved to the spoiler position as the rotor blade rotates toward the tower.

14. The wind turbine of claim 11, wherein the plurality of surface features on a single rotor blade are moveable between the spoiler position and the vortex position independent of one another.

15. The wind turbine of claim 11, wherein a first plurality of surface features on a first rotor blade move between the spoiler position and the vortex generator position independent of a second plurality of surface features on a second rotor blade moving between the spoiler position and the vortex position.

16. The wind turbine of claim 11, wherein the shell comprises one or more openings in at least one of the pressure side and the suction side, and wherein at least one of the plurality of surface features are moveable relative to the one or more openings between a recessed position at least partially disposed within the shell and an extended position at least partially extended out from the shell.

17. The wind turbine of claim 16, wherein at least one of the plurality of surface features are moveable between the spoiler position and the vortex generator position when in the extended position.

18. The wind turbine of claim 16, wherein at least two of the plurality of surface features are moveable between the recessed position and the extended position independent of one another.

19. The wind turbine of claim 16, wherein an outer portion of at least one of the plurality of surface features forms a continuous aerodynamic profile with the shell when in the at least one surface feature is in the recessed position.

20. The wind turbine of claim 11, wherein the plurality of surface features and the shell all comprise the same material.
